(19) United States
(12) Patent Application Publication
(10) Pub. No.: US 2020/0115527 A1
(43) Pub. Date: Apr. 16, 2020

(54) FLAME RETARDANT TREATMENT OF POLYESTER BASED SYNTHETIC FIBER STRUCTURE

(71) Applicants: DAIKYO CHEMICAL CO., LTD., Kyoto (JP); FUSHIMI PHARMACEUTICAL CO., LTD., Kagawa (JP)

(72) Inventors: Terufumu IWAKI, Kyoto (JP); Shigeto KOYAMA, Kagawa (JP); Yuji TADA, Kagawa (JP)

(73) Assignees: DAIKYO CHEMICAL CO., LTD., Kyoto (JP); FUSHIMI PHARMACEUTICAL CO., LTD., Kagawa (JP)

(21) Appl. No.: 16/621,296

(22) PCT Filed: Jun. 16, 2018
(86) PCT No.: PCT/JP2018/023045

§ 371 Date: Dec. 11, 2019

(30) Foreign Application Priority Data
Jun. 22, 2017 (JP) 2017-122436

(51) Int. Cl. C08K 5/5399; C09K 21/12; D06M 13/44

(52) U.S. Cl. CPC C08K 5/5399; D06M 2101/32; D06M 13/44; C09K 21/12

(57) ABSTRACT

The invention provides a flame retardant for a polyester based synthetic fiber structure comprising aminopentaphenoxycyclotriphosphazene, and a flame retardant treatment agent for a polyester based synthetic fiber structure comprising the flame retardant dispersed in a solvent in the presence of a surfactant.

### TECHNICAL FIELD

The present invention relates to a flame retardant treatment for a polyester based synthetic fiber structure. More particularly, the invention relates to a flame retardant for a polyester based synthetic fiber structure which comprises aminopentaphenoxycyclotriphosphazene and imparts flame retardance to a polyester based synthetic fiber structure by post-flame retardant treatment, a polyester based synthetic fiber structure flame retarded by the flame retardant, a flame retardant treatment agent comprising the flame retardant, a flame retardant treatment method of a polyester based synthetic fiber structure making use of the flame retardant treatment agent, and additionally a flame retarded polyester based synthetic fiber structure obtained by the flame retardant treatment method.

Various post-treatment methods for imparting flame retardance to a polyester based synthetic fiber structure have been known. As one of the representative methods, for example, an in-bath treatment method and a padding method may be mentioned.

As a post-treatment method for imparting flame retardance to a polyester based synthetic fiber structure, a method has long been the main stream in which a water-soluble salt such as guanidine phosphate or carbamate phosphate is provided as a flame retardant treatment agent with a polyester based synthetic fiber structure by a padding method. However, there arises a problem in the polyester based synthetic fiber structure flame retarded with such a water soluble salt that crystalline substances precipitate on the surface of the fiber structure due to moisture absorption on or moisture release from the fiber structure. There is a further problem that when water adheres to the surface of the fiber structure, ring stains, also referred to as water marks, result on the surface of the fiber structure (see, for example, Patent Literature 1).

Thus, a method in which an emulsion or a dispersion of a halogen compound or a phosphorus compound is applied to a polyester based synthetic fiber structure by an in bath treatment method or by a padding method have been studied in order to cope with the above-mentioned problems (see, for example, Patent Literatures 2 and 3).

A representative example of the halogen compound is 1,2,5,6,9,10-hexabromocyclododecane (HBCD). However, in recent years, the use thereof has been restricted as it is harmful to the environment.

On the other hand, as the above mentioned phosphorus compounds are known phosphoric esters or phosphoric amides. As these conventionally known phosphoric esters and phosphoric amides are not sufficient in affinity with a polyester based synthetic fiber, when a polyester based synthetic fiber is flame retarded with the phosphoric esters or phosphoric amides by a padding method, a portion thereof is not fixed in the fiber structure and remains on the surface of the fiber structure. Accordingly, it is essential that the thus flame retarded polyester based synthetic fiber structure is washed after the flame retardant treatment. If the flame retarded polyester based synthetic fiber structure is not washed after the flame retardant treatment, there arises a problem that chalk marks are generated on the polyester synthetic fiber structure or friction fastness of the polyester synthetic fiber structure is remarkably deteriorated.

In addition, since the phosphorus compounds such as phosphoric ester and phosphoric amide have a small phosphorus content, it is necessary to provide a large amount of the phosphorus compound with a polyester based synthetic fiber structure in order to impart a satisfactory flame retardance to the fiber structure. This causes a problem of deterioration of texture of the fiber structure.

Meanwhile, because some of the cyclic phosphazene compounds having an amino group, a phenoxy group and/or a methoxy group in the molecule have a high phosphorus content, it is already proposed that they should be used as a flame retardant for a polyester based synthetic fiber structure (For example, see Patent Literatures 4 and 5).

However, the cyclic phosphazene compounds referred to above which have been proposed as a flame retardant are poor in dispersibility in water, inferior in affinity with a polyester based synthetic fiber structure, or liable to hydrolyze under heat and moisture, depending on the structures and the kind of substituents they have. As a result, a polyester based synthetic fiber structure flame retarded by using such a cyclic phosphazene compound as a flame retardant has problems that chalk marks or water marks are generated when water adheres to the surface of the fiber structure, or crystalline substance precipitates on the surface of the fiber structure as time passes.

### PRIOR ART LITERATURE

### Patent Literature

Patent Literature 1: JP2002-38374A
Patent Literature 2: JPS53-8840B
Patent Literature 3: JP2003-193368A
Patent Literature 4: JPH8-291467A
Patent Literature 5: JPH10-298188A

### SUMMARY OF INVENTION

### Technical Problem

The present inventors have extensively and in detail made study of method for production and flame retardant performance of various new cyclic phosphazene compounds having an amino group and/or a phenoxy group in the molecule in order to solve the above mentioned problems involved in the conventional flame retardants for flame retardant treatment of a polyester base synthetic fiber structure. As a result, the inventors have found that aminopentaphenoxycyclotriphosphazene is stable and hardly hydrolyzes, and is additionally superior in affinity with a polyester based synthetic fiber structure, and that it is useful as a flame retardant for a polyester based synthetic fiber structure.

The inventors have found that when a flame retardant treatment agent prepared by dispersing aminopentaphenoxycyclotriphosphazene in a solvent in the presence of a surfactant is provided with a polyester based synthetic fiber structure, for instance, by a padding method, for flame retardant treatment, there is obtained a polyester based synthetic fiber structure which is not accompanied by generation of water marks, chalk marks, deterioration of friction fastness, change in color and precipitation of crystalline substances over time, and thus which has a satisfactory flame retardant performance, even without washing after flame retardant treatment. The inventors have thus arrived at the present invention.

### Solution to Problems

The invention provides a flame retardant for a polyester based synthetic fiber structure comprising aminopentaphenoxycyclotriphosphazene represented by the structural formula (1)

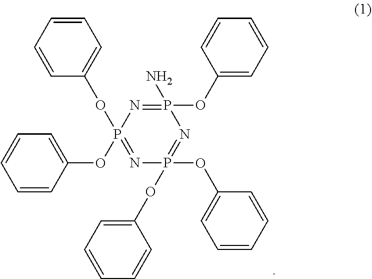 [SMILES: NP1(Oc2ccccc2)=NP(Oc2ccccc2)(Oc2ccccc2)=NP(Oc2ccccc2)(Oc2ccccc2)=N1]

The invention also provides a flame retardant treatment agent for a polyester based synthetic fiber structure comprising the flame retardant dispersed in a solvent in the presence of a surfactant.

In particular, the invention provides the a flame retardant treatment agent for a polyester based synthetic fiber structure comprising the flame retardant dispersed in water as the solvent in the presence of a surfactant.

The invention further provides a polyester based synthetic fiber structure flame retarded by the flame retardant.

The invention also provides a method for flame retardant treatment of a polyester based synthetic fiber structure comprising subjecting a polyester based synthetic fiber structure to flame retardant treatment with the flame retardant treatment agent. In particular, the invention provides a method comprising adhering the flame retardant treatment agent to a polyester based synthetic fiber structure, drying, and then heat treating the same at a temperature of 80 to 200° C., or a method comprising treating a polyester based synthetic fiber structure with the flame retardant treatment agent at a temperature of 100 to 140° C. in a bath.

In addition, the invention provides a polyester based synthetic fiber structure flame retarded by the method of flame retardant treatment mentioned above.

### Effects of Invention

The flame retardant treatment of a polyester based synthetic fiber structure using a flame retardant treatment agent comprising the flame retardant according to the invention provides a satisfactory flame retardance with the polyester based synthetic fiber structure without deterioration of properties of the fiber structure such as generation of water marks or chalk marks, reduction in friction fastness, or color in change or precipitation of crystalline substance over time.

Moreover, according to the flame retardant treatment of a polyester based synthetic fiber structure using the flame retardant treatment agent according to the invention, there is no need of washing the polyester based synthetic fiber structure after the flame retardant treatment so that the work load in the flame retardant treatment is drastically reduced.

### DESCRIPTION OF EMBODIMENTS

In the invention, the polyester based synthetic fiber structure refers to a fiber containing at least polyester fiber therein and a fabric such as yarn, cotton, knitted fabric or nonwoven fabric comprising such a fiber, preferably polyester fiber and fabric such as yarn, cotton, knitted fabric or nonwoven fabric formed of the polyester fiber. Further, the fabric such as the woven or nonwoven fabric may be of a single layer or of a laminate of two or more layers, or even a composite composed of yarn, cotton, woven or nonwoven fabric.

In the invention, the polyester fiber may be of polyethylene terephthalate, polypropylene terephthalate, polybutylene terephthalate, polyethylene naphthalate, polybutylene naphthalate, polyethylene terephthalate/isophthalate, polyethylene terephthalate/5-sulfoisophthalate, polyethylene terephthalate/polyoxybenzoyl, polybutylene terephthalate/isophthalate; poly(D-lactic acid), poly (L-lactic acid), a copolymer of D-lactic acid and L-lactic acid, a copolymer of D-lactic acid and an aliphatic hydroxycarboxylic acid, a copolymer of L-lactic acid and an aliphatic hydroxycarboxylic acid, polycaprolactone such as poly-ε-caprolactone (PCL); a polyaliphatic hydroxycarboxylic acid such as polymalic acid, polyhydroxybutyric acid, polyhydroxyvaleric acid, a random copolymer of 8-hydroxybutyric acid (31113) and 3-hydroxyvaleric acid (3HV); a polyester of a glycol and an aliphatic dicarboxylic acid such as polyethylene succinate (PES), polybutylenesuccinate (PBS), polybutyleneadipate, and polybutylenesuccinate-adipate copolymer. However, the polyester fiber is not limited to those exemplified above.

The polyester fiber may be formed of a copolymer of polyester and a functional compound such as a flame retardant, which is incorporated into the polyester while it is produced, or may be formed of a polyester blended with a functional compound such as an antibacterial agent, which is incorporated into the polyester while it is produced or spun.

The polyester based synthetic fiber structure flame retarded according to the invention is suitably used for a seat, a seat cover, a curtain, a wallpaper, a ceiling cross, a carpet, a thick curtain, a protective sheet for construction use, a tent, a canvas and the like.

The flame retardant for a polyester based synthetic fiber structure according to the invention comprises aminopentaphenoxycyclotriphosphazene represented by the following structural formula (1):

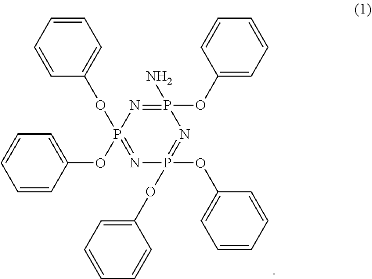 [SMILES: NP1(Oc2ccccc2)=NP(Oc2ccccc2)(Oc2ccccc2)=NP(Oc2ccccc2)(Oc2ccccc2)=N1]

The aminopentaphenoxycyclotriphosphazene is obtained, for example, by reacting hexachlorocyclotriphosphazene with sodium phenoxide in an appropriate organic solvent to obtain a reaction mixture containing monochloropentaphenoxycyclotriphosphazene as a main component, reacting the main component with ammonia in a pressure-resistant container under sealed conditions, and removing by-products from the obtained reaction mixture.

Of course, the flame retardant according to the invention may contain other aminophenoxycyclotriphosphazenes, and may further contain other conventionally known flame retardants as long as the effect of the flame retardant of the invention is not adversely affected.

According to the invention, the flame retardant, the aminopentaphenoxycyclotriphosphazene, is used preferably in the form of a flame retardant treatment agent comprising an appropriate solvent and the flame retardant dispersed therein.

That is, the flame retardant treatment agent for a polyester based synthetic fiber structure according to the invention comprises a solvent and the flame retardant dispersed therein in the presence of a surfactant. The preferred solvent for the flame retardant treatment agent, that is, the dispersing medium is water.

However, the dispersing medium may be an organic solvent as long as it does not affect adversely the performance of the flame retardant treatment agent of the invention. Further, the dispersing medium may be an organic solvent, or may be a mixture of an organic solvent, particularly a water-soluble organic solvent, and water.

Therefore, the flame retardant treatment agent of the invention is preferably obtained by mixing the aminopentaphenoxycyclotriphosphazene with water together with a surfactant, and wet grinding the aminopentaphenoxycyclotriphosphazene with a wet grinding mill to provide fine particles.

In the invention, any of an anionic surfactant, a nonionic surfactant and a cationic surfactant may be used as the surfactant.

However, according to the invention, a preferred surfactant used is at least one selected from the group consisting of:

(a) a polyoxyethylene polyoxypropylene alkyl ether represented by the general formula (I):

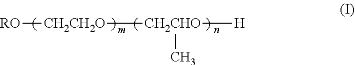

wherein R is a linear or branched alkyl group having 6 to 18 carbon atoms, and may be saturated or unsaturated, m is an average number of moles of addition of ethylene oxide, and is an integer of 1 to 20 on average, and n is an average number of moles of addition of propylene oxide and is an integer of 1 to 20 on average;

(b) a sulfuric ester salt of an arylated phenol ethylene oxide adduct represented by the general formula (II):

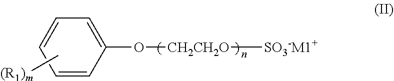

wherein R₁ represents a benzyl group, a styryl group or a cumyl group, m is an integer of 1 to 3 on average, n is an average number of moles of addition of ethylene oxide and is an integer of 5 to 30 on average, and M₁⁺ represents an alkali metal ion or an ammonium ion, and

(c) a sulfosuccinic ester salt of a styrenated phenol ethylene oxide adduct represented by the general formula (III):

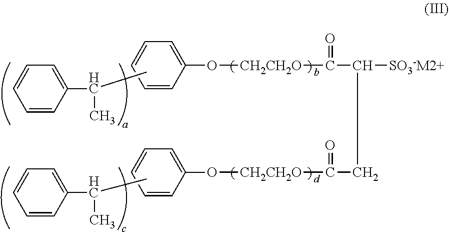

wherein M2⁺ represents an alkali metal ion or an ammonium ion, a and c each independently represents an integer of 1 to 3 on average, b and d each represents an average number of moles of addition of ethylene oxide and is independently an integer of 5 to 30 on average.

In the sulfuric ester salt of an arylated phenol ethylene oxide adduct represented by the general formula (II) or the sulfosuccinic ester salt of a styrenated phenol ethylene oxide adduct represented by the general formula (III), when M1⁺ or M2⁺ is an alkali metal ion, it is preferably sodium ion or potassium ion.

In the invention, the before mentioned preferred surfactant is used usually in the range of 3 to 15 parts by weight based on 100 parts by weight of the aminopentaphenoxycyclotriphosphazene.

When the amount of the preferred surfactant used is more than 15 parts by weight relative to 100 parts by weight of the aminopentaphenoxycyclotriphosphazene, there are fears that the obtained flame retarded polyester based synthetic fiber structure has a reduced friction fastness and that water marks are generated on the obtained flame retarded polyester based synthetic fiber structure. On the other hand, when the amount of the preferred surfactant used is less than 3 parts by weight relative to 100 parts by weight of the aminopentaphenoxycyclotriphosphazene, it may happen that the aminopentaphenoxycyclotriphosphazene is not dispersed in water according to circumstances.

Also, in the invention, the amount of the flame retardant in the flame retardant treatment agent is not particularly limited, but it is usually in the range of 20 to 50% by weight based on the weight of the flame retardant treatment agent.

In the invention, other anionic surfactants or nonionic surfactants other than the before mentioned preferred surfactants may be used together as a second surfactant if necessary with the preferred surfactants to the extent that when the preferred surfactants are dispersed in water, they are not adversely affected. A cationic surfactant may also be used as a second surfactant.

Examples of anionic surfactants as the second surfactants include sulfuric ester salts such as higher alcohol sulfuric ester salts, higher alkyl ether sulfuric ester salts, sulfated fatty acid ester salts and the like: sulfonic acid salts such as alkylbenzenzenesulfonic acid salts or alkylnaphthalenesulfonic acid salts and the like; higher alcohol phosphoric ester salts, higher alcohol alkylene oxide adducts phosphoric ester salts, alkali metal salts or ammonium salts of a hydrolyzate of a diisobutylene-maleic anhydride copolymer, alkali metal salts or ammonium salts of a hydrolyzate of a styrene-maleic anhydride copolymer, alkali metal salts or ammonium salts of a half esterified product of a diisobutylene-maleic anhydride copolymer, alkali metal salts or ammonium salts of a half esterified product of styrene-maleic anhydride copolymer, alkali metal salts or ammonium salts of styrene-(meth)acrylic acid copolymer, polyacrylic acid metal salts, and so on.

Examples of nonionic surfactants as the second surfactants include, for example, polyoxyalkylene type nonionic surfactants such as an arylated phenol alkylene oxide adduct, an alkylphenol alkylene oxide adduct, a higher alcohol alkylene oxide adduct, a fatty acid alkylene oxide adduct, a polyhydric alcohol aliphatic ester alkylene oxide adduct, a higher alkylamine alkylene oxide adduct and a fatty acid amide alkylene oxide adduct; and polyhydric alcohol type nonionic surfactants such as alkylglycoxides and sucrose fatty acid esters.

Examples of cationic surfactants as the second surfactants include alkylamine salts, quaternary ammonium salts, polyoxyethylene alkylamines, polyethylene polyamine derivatives, and the like.

When the second surfactant, an anionic, nonionic or cationic, is used in combination with any of the preferred surfactants, i.e., the polyoxyethylene polyoxypropylene alkyl ether, the sulfuric ester salt of the arylated phenol ethylene oxide adduct, or the sulfosuccinate ester salt of the styrenated phenol ethylene oxide adduct, the second surfactant may be used singly or in combination of two of these surfactants.

According to the invention, the flame retardant treatment agent may contain, as a dispersing aid, a protective colloid agent such as polyvinyl alcohol, methyl cellulose, carboxymethyl cellulose, guar gum, xanthan gum, or a starch paste in addition to the before mentioned preferred surfactant to the extent that the flame retardant treatment agent is not adversely affected so that not only the agent has an improved storage stability but also the flame retardant is well dispersed in a solvent.

In the invention, examples of the organic solvent usable as a dispersing medium in which the flame retardant is dispersed include alcohols such as methanol and ethanol, aromatic hydrocarbons such as toluene, xylene, alkylnaphthalene and the like, ketones such as acetone or methyl ethyl ketone, ethers such as dioxane and ethyl cellosolve, amides such as dimethylformamide, sulfoxides such as dimethylsulfoxide, and halogenated hydrocarbons such as methylene chloride and chloroform.

In particular, as preferred organic solvents are mentioned a water-soluble organic solvent such as alcohols such as methanol, ethers such as acetone, ethyl cellosolve, etc., amides such as dimethylformamide, and sulfoxides such as dimethyl sulfoxide. These organic solvents may be used alone or in combination of two or more, or may be used as a mixture with water.

In general, when a flame retardant is provided with a polyester based synthetic fiber structure for flame retardant treatment, the average particle diameter of the flame retardant has a substantial influence on the flame retardance performance of the resulting flame retarded polyester based synthetic fiber structure. The smaller the average particle diameter of the flame retardant is, the higher flame retardance performance is imparted to the polyester base synthetic fiber structure. On the other hand, as the average particle diameter of the flame retardant increases, the flame retardant treatment agent has a reduced storage stability so that the flame retardant precipitates to become solid, and undesirably forms a so-called hard cake in the flame retardant treatment agent as time passes.

Therefore, according to the invention, when the polyester based synthetic fiber structure is subjected to flame retardant treatment by using the flame retardant treatment agent, it is preferred that the flame retardant, the aminopentaphenoxycyclotriphosphazene, is used as a flame retardant treatment agent which comprises the flame retardant dispersed in water as fine particles preferably having an average particle diameter of 3 μm or less so that the flame retardant sufficiently diffuses and adheres inside the polyester based synthetic fiber structure so that it is provided with a durable flame retardance. It is particularly preferred that the flame retardant is dispersed in water as fine particles having an average particle diameter in the range of 0.3 to 1.0 μm.

In the flame retardant treatment of a polyester based synthetic fiber structure using the flame retardant treatment agent according to the invention, the flame retardant treatment agent is usually diluted with water so that it is used as a treatment liquid. The treatment liquid preferably contains the aminopentaphenoxycyclotriphosphazene usually in the range of 0.5 to 5% by weight according to the invention, although not specifically limited.

When a polyester based synthetic fiber structure is subjected to flame retardant treatment using the flame retardant treatment agent of the invention, the necessary amount of the flame retardant to be adhered to or provided with the polyester based synthetic fiber structure, that is, the amount of flame retardant adhesion, depends on the form and kind of the polyester based synthetic fiber structure to be flame retarded. Thus, the necessary amount of the flame retardant is not limited, but it is usually in the range of 0.6 to 5% by weight.

When the amount of adhesion exceeds 5% by weight, there arises a problem that the flame retarded polyester based synthetic fiber structure has a texture rough and hard.

In order to impart flame retardance to a polyester based synthetic fiber structure using the flame retardant of the invention, a method may be adopted in which the flame retardant of the invention is kneaded into a polyester based synthetic fiber when it is spun. However, as described hereinbefore, it is preferred to subject a polyester based synthetic fiber structure to flame retardant treatment as a post treatment using the flame retardant treatment agent according to the invention.

A method for imparting flame retardance to a polyester based synthetic fiber structure by post treatment is not particularly limited. However, as one of preferred methods, for example, a flame retardant treatment agent is adhered and attached to a polyester based synthetic fiber structure, and dried, followed by heat treatment at a temperature in the range of 80 to 200° C. for 1 to 5 minutes so that the aminopentaphenoxycyclotriphosphazene of the invention is exhausted inside the fiber. In this method, for example, a padding method, a spray method, a coating method, or the like may be employed to adhere the flame retardant treatment agent to a polyester based synthetic fiber structure.

In the padding method, for example, a polyester based synthetic fiber structure such as a fabric is immersed in the flame retardant treatment agent or a treatment liquid obtained by diluting the flame retardant treatment agent, and the fabric is then squeezed with a roller (mangle) thereby the flame retardant is adhered to the fabric. In the spraying method, the flame retardant treatment agent or a treatment liquid obtained by diluting the flame retardant treatment agent is sprayed in the form of mist to adhere the flame retardant treatment agent into the fabric. In the coating method, the flame retardant treatment agent is thickened and uniformly applied onto the back surface of the fabric, thereby adhering the flame retardant to the fabric.

According to the invention, the aminopentaphenoxycyclotriphosphazene is adhered to a polyester based synthetic fiber structure in this manner, dried, and heat treated at a temperature of 80 to 200° C. for 1 to 5 minutes so that it is exhausted inside the fiber, thereby imparting a superior flame retardance to the polyester based synthetic fiber structure.

As another method for subjecting a polyester based synthetic fiber structure to flame retardant treatment using the flame retardant treatment agent of the invention, for example, there may be mentioned an in-bath treatment method in which a polyester based synthetic fiber structure is immersed in a flame retardant treatment agent or a treatment liquid obtained by diluting the flame retardant treatment agent and treated in a bath at a temperature of 100 to 140° C. so that the flame retardant is exhausted inside the fiber using a package dyeing machine such as a jet dyeing machine, a beam dyeing machine, a cheese dyeing machine or the like.

According to the invention, when the flame retardant treatment agent is applied to a polyester based synthetic fiber structure by the in-bath treatment method as mentioned above, the flame retardant treatment agent may be applied before or after dyeing, or simultaneously with dyeing.

The flame retardant treatment agent of the invention may contain a flame retardant auxiliary to enhance the flame retardance of the flame retardant treatment agent, or an ultraviolet absorber to increase light fastness, or an antioxidant in addition to the above mentioned if necessary so long as the performance of the flame retardant treatment agent of the invention is not impaired. Further, if necessary, the flame retardant treatment agent of the invention may contain conventionally known flame retardants.

The flame retardant treatment agent according to the invention may be used in combination with conventionally known other fiber treatment agents as long as it does not adversely affect the flame retardance which the flame retardant treatment agent according to the invention imparts to the polyester based synthetic fiber structure. Examples of such fiber treatment agents include softening agents, antistatic agents, water- and oil-repellent agents, hard-finish agents, texture regulating agents and the like.

### EXAMPLES

The invention will be hereinafter described in detail with reference to Reference Examples showing a method for synthesizing a flame retardant of the invention and Examples showing production of flame retardant treatment agent of the invention and flame retardant treatment according to the invention, together with Comparative Examples. However, the invention is in no way limited by these examples.

In the following, the nonvolatile content in the flame retardant treatment agent refers to the proportion of the flame retardant in the flame retardant treatment agent. When the flame retardant treatment agent contains a surfactant and a defoaming agent together with the flame retardant therein, the nonvolatile content refers to the proportion of the total amount of the flame retardant, surfactant and defoaming agent in the flame retardant treatment agent.

The average particle diameter of the flame retardant refers to the volume-based median diameter obtained by measuring the particle size distribution of the flame retardant in the flame retardant treatment agent with a laser diffraction type particle size distribution measuring apparatus SALD-2000J manufactured by Shimadzu Corporation.

In the following description, “%” and “part” refer “% by weight” and “parts by weight”, respectively, unless otherwise specified.

The phosphazene compounds obtained in the following Reference Examples were identified based on the results obtained by measurement of ¹H-NMR and ³¹P-NMR spectra, analysis of chlorine element (residual chlorine) by a potentiometric titration method using silver nitrate, and analysis by LC/MS analysis. The melting point and 5% weight loss temperature of those phosphazene compounds were also measured by TG/DTA analysis.

### A. Production of Flame Retardant

### Reference Example 1

### Synthesis of Aminopentaphenoxycyclotriphosphazene

521 g (1.50 mol) of hexachlorocyclotriphosphazene was placed in a 10 L flask equipped with a stirrer, a thermometer and a reflux condenser, and then 2000 mL of toluene to dissolve the hexachlorocyclotriphosphazene therein to obtain a toluene solution of hexachlorocyclotriphosphazene.

A solution of 784 g (6.75 mol) of sodium phenoxide in 3000 mL of THF (tetrahydrofuran) was added dropwise to the toluene solution of hexachlorocyclotriphosphazene at an internal temperature of 20 to 35° C. The resulting reaction mixture was heated and refluxed for one hour. Then, THF was distilled off from the reaction mixture, and the mixture was stirred at 110° C. for 8 hours.

The reaction mixture thus obtained was washed with 2000 mL of 2% aqueous solution of sodium hydroxide and then washed twice with 1000 mL of demineralized water. Toluene and a trace amount of water were distilled off from the obtained toluene layer to obtain 892 g of a solid reaction product. The solid reaction product was analyzed by HPLC using an authentic sample prepared in advance, and as a result, the solid reaction product was confirmed to mainly comprise monochloropentaphenoxycyclotriphosphazene and dichlorotetraphenoxycyclotriphosphazenes.

891 g of the solid reaction product and 350 mL of toluene were put in a 2 L stainless steel pressure-resistant container. After the inside of the pressure-resistant container was evacuated to 400 hPa, 131 g (7.72 mol) of ammonia was added thereinto, and mixture inside the container was stirred at 50° C. for 15 hours under sealed conditions. Thereafter, the pressure-resistant container was opened, and 3500 mL of toluene was added to the reaction product for dilution, and then the toluene layer was washed with demineralized water.

The toluene layer was concentrated under reduced pressure to obtain 812 g of a yellowish brown viscous material. 123 g of the viscous material was purified with a column packed with silica gel using ethyl acetate and hexane as an eluent. The fraction containing the desired product was concentrated under reduced pressure, followed by cooling to room temperature to provide 43.2 g of a white solid.

The analysis results of the above white solid are shown below.

¹H-NMR spectrum (300 MHz, CDCl₃, δ, ppm):

N—H: 2.6 (2H)

C—H: 6.8-7.5 (25H),

³¹P-NMR spectrum (1.21 MHz, CDCl₃, δ, ppm):

P—(OPh)₂: 9.3-10.1 (2P),

P—(NH₂)(OPh): 18.4-19.8 (1P),

LC/MS (positive-ESI) m/z: 617 (M+H⁺),

Hydrolyzed chlorine: 0.01% or less,

TG/DTA analysis:

melting point: 76° C.

5% weight loss temperature: 315° C.

From the above analysis results, the white solid was confirmed to be aminopentaphenoxycyclotriphosphazene. Yield: 30.7%, HPLC purity: 99.3% (area percentage).

### Reference Example 2

### Synthesis of 2,2-diamino-4,4,6,6-tetraphenoxycyclotriphosphazene

In a 5 L flask equipped with a stirrer, a thermometer and a reflux condenser, 521 g (1.50 mol) of hexachlorocyclotriphosphazene and 2150 mL of diethyl ether were placed, and stirred with cooling in a water bath to dissolve the hexachlorocyclotriphosphazene in diethyl ether thereby to obtain a diethyl ether solution of hexachlorocyclotriphosphazene.

While stirring the solution, 766 g (11.3 mol as ammonia) of 25% ammonia water was added dropwise thereto at an internal temperature of 25° C. or less, and the mixture was reacted at an internal temperature of 30° C. for 2 hours. The resulting reaction mixture was transferred to a separatory funnel to separate an aqueous layer, and the diethyl ether layer was washed with demineralized water until it became neutral.

The obtained diethyl ether layer was dehydrated and then diethyl ether was distilled off to obtain 276 g of 2,2-diamino-4,4,6,6-tetrachlorocyclotriphosphazene as a pale yellow solid. Yield: 59.6%.

The analysis results of the pale yellow solid are shown below.

¹H-NMR spectrum (300 MHz, acetone-d₆, δ, ppm):

N—H: 2.1 (m)

C—H: 6.8-7.5 (20H),

³¹P-NMR spectrum (121 MHz, acetone-d₆, δ, ppm):

P—(NH₂)₂: 10.0-12.0 (1P),

P—Cl: 18.0-20.0 (2P)

276 g (0.894 mol) of 2,2-diamino-4,4,6,6-tetrachlorocyclotriphosphazene was placed in a 5 L capacity flask equipped with a stirrer, a thermometer and a reflux condenser, and then 1200 mL of THF was placed. The resulting mixture was stirred to dissolve the 2,2-diamino-4,4,6,6-tetrachlorocyclotriphosphazene in TIF to obtain a TH F solution of thereof.

A THF solution of 622 g (5.36 mol) of sodium phenoxide in 2500 mL of THF was added dropwise to the THF solution of 2,2-diamino-4,4,6,6-tetrachlorocyclotriphosphazene at an internal temperature of 25° C. or less, and then the mixture was refluxed for 15 hours. After completion of the reaction, THF was distilled off from the resulting reaction mixture under reduced pressure. The obtained residue was dissolved in 2000 mL of diethyl ether. The resulting diethyl ether solution was washed with 2000 mL of 2% aqueous solution of sodium hydroxide, and then washed twice with 1000 mL of demineralized water.

The obtained diethyl ether layer was dehydrated, diethyl ether was distilled off, 660 ml, of hexane was added to the obtained residue, and the mixture was stirred for one hour and then filtered. The obtained solid was dried under reduced pressure at 60° C. to obtain 433 g of 2,2-diamino-4,4,6,6-tetraphenoxycyclotriphosphazene as a white solid.

The analysis results of the above white solid are shown below.

¹H-NMR spectrum (300 MHz, CDCl₃, δ, ppm):

N—H: 2.2 (4H),

C—H: 7.0-7.5 (20H),

³¹P-NMR spectrum (121 MHz, CDCl₃, δ, ppm):

P—(OPh)₂: 10.0-11.5 (2P),

P—(NH₂)₂: 18.5-20.5 (1P),

LC/MS (positive-ESI) m/z: 540 (M+t*);

Hydrolyzed chlorine: 0.01.% or less,

TG/DTA analysis:

Melting point: 107° C.

5% weight loss temperature: 344° C.

From the above analysis results, the white solid was confirmed to be 2,2-diamino-4,4,6,6-tetraphenoxycyclotriphosphazene. Yield: 53.5%, HPLC purity: 99.9% (area percentage).

### Reference Example 3

### Synthesis of 2,2,4-triamino-4,6,6-triphenoxycyclotriphosphazene

In a 10 L flask equipped with a stirrer, a thermometer and a reflux condenser, 521 g (1.50 mol) of hexachlorocyclotriphosphazene and 2000 mL of toluene were placed. The hexachlorocyclotriphosphazene was dissolved in the toluene to obtain a toluene solution of hexachlorocyclotriphosphazene.

A THF solution of 540 g (4.65 mol) of sodium phenoxide in 2200 mL of THF was added dropwise to the above toluene solution of hexachlorocyclotriphosphazene at an internal temperature in the range of 20 to 35° C. The mixture was then heated and refluxed for one hour. THF was then distilled off from the resulting reaction mixture, and the mixture was stirred at 110° C. for 8 hours.

The reaction mixture thus obtained was washed with 2000 mL of 2% aqueous solution of sodium hydroxide and then washed twice with 1000 mL of demineralized water. Toluene and a trace amount of water were distilled off from the obtained toluene layer to obtain 765 g of a mixture of chlorophenoxycyclotriphosphazenes. The mixture was analyzed by HPLC using an authentic sample prepared beforehand, and was confirmed to contain 2,2,4-trichloro-4,6,6-triphenoxycyclotriphosphazene.

764 g of the mixture of chlorophenoxycyclotriphosphazenes and 300 mL of toluene were placed in a 2 L stainless steel pressure-resistant container. After the inside of the pressure-resistant container was evacuated to 400 hPa, 251 g (14.8 mol) of ammonia was added thereinto. The mixture was stirred at 50° C. for 15 hours under sealed conditions. Thereafter, the pressure-resistant container was opened. 3500 mL of toluene was added to the reaction product to be diluted, and the toluene layer was washed with demineralized water.

The toluene layer was concentrated under reduced pressure to obtain 464 g of a yellowish brown viscous material. 28.1 g of the viscous material was purified with a column packed with silica gel using ethyl acetate and hexane as an eluent. The fraction containing the desired product was concentrated under reduced pressure and then cooled to room temperature to obtain 1.2.9 g of a white solid.

The analysis results of the above white solid are shown below.

¹H-NMR spectrum (300 MHz, CDCl₃, δ, ppm):

N—H: 1.6-2.8 (6H)

C—H: 7.1-7.4 (15H),

³¹P-NMR spectrum (121 MHz, CDCl₃, δ, ppm):

P—(OPh)₂: 9.9-11.3 (1P),

P—(NH₂)₂, P—(NH₂)(OPh): 17.8-20.5 (2P),

LC/MS (positive-ESI) m/z: 463 (M+H⁺),

Hydrolyzed chlorine: 0.01% or less,

TG/DTA analysis:

Melting point: 138° C.

5% weight loss temperature: 259° C.

From the above analysis results, the white solid was confirmed to be 2,2,4-triamino-4,6,6-triphenoxycyclotriphosphazene. Yield: 30.8%, HPLC purity: 99.4% (area percentage).

### Reference Example 4

### Synthesis of 2,4-diamino-2,4,6,6-tetraphenoxycyclotriphosphazene

In a 10 L, flask equipped with a stirrer, a thermometer and a reflux condenser was placed 521 g (1.50 mol) of hexachlorocyclotriphosphazene and 2000 mL of toluene to dissolve the hexachlorocyclotriphosphazene in toluene to obtain a toluene solution of hexachlorocyclotriphosphazene.

A solution of 697 g (6.00 mol) of sodium phenoxide in 2700 mL of THF was added dropwise to the toluene solution of hexachlorocyclotriphosphazene at an internal temperature of 20 to 35° C. The mixture was heated and refluxed for one hour. THF was then distilled off from the obtained reaction mixture, and the mixture was stirred at 110° C. for 8 hours.

The reaction mixture thus obtained was washed with 2000 mL of 2% aqueous solution of sodium hydroxide and then washed twice with 1000 mL of demineralized water. Toluene and a trace amount of water were distilled off from the resulting toluene layer to obtain 688 g of a mixture of chlorophenoxycyclotriphosphazenes. The mixture was analyzed by HPLC using an authentic sample prepared in advance, and the mixture was confirmed to contain 2,4-dichloro-2,4,6,6-tetraphenoxycyclotriphosphazene.

688 g of the mixture of chlorophenoxycyclotriphosphazenes and 600 mL of toluene were placed in a 2 L stainless steel pressure-r-resistant container. After the pressure-resistant container was evacuated to 400 hPa, 134 g (7.85 mol) of ammonia was added thereinto. The mixture was stirred at 50° C. for 15 hours under sealed conditions. Thereafter, the pressure-resistant container was opened, and 4500 mL of toluene was added to the reaction mixture to dissolve the reaction mixture therein, which was then washed twice with diluted hydrochloric acid and 1000 mL of demineralized water.

The reaction mixture was subjected to purification treatment with silica gel-packed column chromatography by using a mixture of ethyl acetate and hexane as an eluent to separate the by-products, aminopentaphenoxycyclotriphosphazene, triaminotriphenoxycyclotriphosphazene and others from the reaction mixture.

The eluent was concentrated under reduced pressure to obtain the residue as an ethyl acetate solution. The crystals precipitated therefrom were filtered and dried to obtain 484 g of 2,4-diamino-2,4,6,6-tetraphenoxycyclotriphosphazene as a white solid.

The analysis results of the above white solid are shown below.

¹H-NMR spectrum (300 MHz, CDCl₃, 6, ppm):

N—H: 2.6, 2.8 (4H)

C—H: 6.8-7.5 (20H).

³¹P-NMR spectrum (1.21 MHz, CDCl₃, δ, ppm):

P—(OPh)₂: 8.5-10.5 (1P),

P—(NH₂)(OPh): 18.0-20.0 (2P),

LC/MS (positive ESI) m/z: 540 (M+H⁺),

Hydrolyzed chlorine: 0.01% or less,

T/DTA analysis:

Melting point: 97° C.

5% weight loss temperature: 298° C.

From the above analysis results, the white solid was confirmed to be 2,4-diamino-2,4,6,6-tetraphenoxycyclotriphosphazene. Yield: 59.8%, HPLC purity: 99.3% (area percentage).

### Reference Example 5

### Synthesis of 2,4,6-triamino-2,4,6-triphenoxycyclotriphosphazene

In a 10 L flask equipped with a stirrer, a thermometer and a reflux condenser was placed 521 g (1.50 mol) of hexachlorocyclotriphosphazene and 2000 mL of toluene to dissolve the hexachlorocyclotriphosphazene in toluene to obtain a toluene solution of hexachlorocyclotriphosphazene.

A THF solution of 610 g (5.25 mol) of sodium phenoxide in 2400 ml of THF was added dropwise to the toluene solution of hexachlorocyclotriphosphazene at an internal temperature of 20 to 35° C. The obtained mixture was heated and refluxed for one hour. THF was distilled off from the resulting reaction mixture, and the remained mixture was stirred at 110° C. for 8 hours.

The reaction mixture thus obtained was washed with 2000 mL of 2% aqueous solution of sodium hydroxide and then washed twice with 1000 mL of demineralized water. Toluene and a trace amount of water were distilled off from the obtained toluene layer to obtain 850 g of a mixture of chlorophenoxycyclotriphosphazenes. The mixture was analyzed by HPLC using an authentic sample prepared in advance, and was confirmed to contain 2,4,6-trichloro-2,4,6-triphenoxycyclotriphosphazene.

849 g of the mixture of chlorophenoxycyclotriphosphazenes and 320 mL of toluene were placed in a 2 L stainless steel pressure-resistant container. The pressure-resistant container was evacuated to 400 hPa, and then 221 g (13.0 mol) of ammonia was added into the container. The mixture inside the container was stirred at 50° C. for 15 hours under sealed conditions. Then, the pressure-resistant container was opened, and 3600 mL of toluene was added to the reaction product to be diluted, and filtered. Methanol was added to the resulting filter cake, heated to dissolve the cake therein, and the resultant was cooled to room temperature. The precipitated solid was collected by filtration and dried to obtain 321 g of a white solid.

The analysis results of the white solid are shown below.

¹H-NMR spectrum (300 MHz, DMSO-de, δ, ppm):

N—H: 4.1 (6H)

C—H: 6.8-7.5 (15H),

³¹P-NMR (121 MHz, DMSO-d₆, δ, ppm):

P—(NH₂)(OPh): 17.3-17.7 (3P),

LC/MS (positive ESI) m/z: 463 (M+H⁺),

Hydrolyzed chlorine: 0.01% or less,

TG/DTA analysis:

Melting point: 21.3° C.

5% weight loss temperature: 278° C.

From the above analysis results, the white solid was confirmed to be 2,4,6-triamino-2,4,6-triphenoxycyclotriphosphazene. Yield: 46.3%, HPLC purity: 99.1% (area percentage).

### B. Production of Flame Retardant Treatment Agent

### Example 1

### (Production of Flame Retardant Treatment Agent A)

27 parts by weight of aminopentaphenoxycyclotriphosphazene, 0.5 parts by weight of polyoxyethylene (5 mol) polyoxypropylene (9 mol) octyl ether, 1.0 part by weight of ammonium salt of sulfuric ester of tristyrenated phenol ethylene oxide 10 mol adduct and 0.05 parts by weight of silicone defoaming agent were mixed with 35 parts by weight of water. The resulting mixture was placed in a mill containing glass beads having a diameter of 0.8 mm and pulverized for 3 hours to disperse the aminopentaphenoxycyclotriphosphazene in water as fine particles having an average particle diameter of 0.529 μm. The amount of water of the thus obtained dispersion was adjusted so that the dispersion had a concentration of nonvolatile component of 28.6% by weight when the dispersion was dried at a temperature of 105° C. for 40 minutes, thereby to obtain a flame retardant treatment agent A of the invention.

### Comparative Example 1

### (Production of Flame Retardant Treatment Agent B)

47 parts by weight of guanidine phosphate was dissolved in 53 parts by weight of water to obtain a flame retardant treatment agent B of a comparative example.

### Comparative Example 2

### (Production of Flame Retardant Treatment Agent C)

40 parts by weight of anilinodiphenyl phosphate, 1.5 parts by weight of ammonium salt of sulfuric ester of tristyrenated phenol ethylene oxide 10 mol adduct and 0.05 parts by weight of silicone defoaming agent were mixed with 35 parts by weight of water. The resulting mixture was placed in a mill containing glass beads having a diameter of 0.8 mm and pulverized for 4 hours to disperse the anilinodiphenyl phosphate in water as fine particles having an average particle size of 0.547 μm to obtain a dispersion. The amount of water of the thus obtained dispersion was adjusted so that the dispersion had a concentration of nonvolatile component of 41.6% by weight when the dispersion was dried at a temperature of 105° C. for 40 minutes, thereby to obtain a flame retardant treatment agent C of a comparative example.

### Comparative Example 3

### (Production of Flame Retardant Treatment Agent D)

40 parts by weight of crystalline powder of tetra-(2,6-dimethylphenyl)-m-phenylenephosphate, 1.5 parts by weight of ammonium salt of sulfuric ester of tristyrenated phenol ethylene oxide 10 mol adduct and 0.05 parts by weight of a silicone defoaming agent were mixed with 35 parts by weight of water. The obtained mixture was pulverized with a homogenizer at 3000 rpm for one hour to obtain a treatment liquid containing the phosphate having an average particle diameter of 50 μm or less.

The treatment liquid was placed in a mill containing glass beads having a diameter of 0.8 mm and pulverized for 3 hours to disperse the phosphate in water as fine particles having an average particle diameter of 1.142 μm to obtain a dispersion. The amount of water of the thus obtained dispersion was adjusted so that the dispersion had a concentration of nonvolatile component of 41.6% by weight when the dispersion was dried at a temperature of 105° C. for 40 minutes, thereby to obtain a flame retardant treatment agent D) of a comparative example.

### Comparative Example 4

### (Production of Flame Retardant Treatment Agent E)

20 parts by weight of hexaaminocyclotriphosphazene was dissolved in 80 parts by weight of water to obtain a flame retardant treatment agent E of a comparative example.

### Comparative Example 5

### (Production of Flame Retardant Treatment Agent F)

27 parts by weight of 2,2-diamino-4,4,6,6-tetraphenoxycyclotriphosphazene, 1.5 parts by weight of ammonium salt of sulfuric ester of tristyrenated phenol ethylene oxide 10 mol adduct and 0.05 parts by weight of silicone defoaming agent were mixed with 35 parts by weight of water. The resulting mixture was placed in a mill containing glass beads having a diameter of 0.8 mm and pulverized for 3 hours to disperse the phosphazene compound in water as fine particles having an average particle diameter of 0.435 μm to obtain a dispersion. The amount of water of the thus obtained dispersion was adjusted so that the dispersion had a concentration of nonvolatile component of 28.6% by weight when the dispersion was dried at a temperature of 105° C. for 40 minutes, thereby to obtain a flame retardant treatment agent F of a comparative example.

### Comparative Example 6

### (Production of Flame Retardant Treatment Agent G)

27 parts by weight of 2,2,4-triamino-4,6,6-triphenoxycyclotriphosphazene, 1.5 parts by weight of ammonium salt of sulfuric ester of tristyrenated phenol ethylene oxide 10 mol adduct and 0.05 parts by weight of silicone defoaming agent were mixed with 35 parts by weight of water. The resulting mixture was placed in a mill containing glass beads having a diameter of 0.8 mm and pulverized for 3 hours to disperse the phosphazene compound in water as fine particles having an average particle diameter of 0.444 μm to obtain a dispersion. The amount of water of the thus obtained dispersion was adjusted so that the dispersion had a concentration of nonvolatile component of 28.6% by weight when the dispersion was dried at a temperature of 105° C. for 40 minutes, thereby to obtain a flame retardant treatment agent G of a comparative example.

### Comparative Example 7

### (Production of Flame Retardant Agent H)

27 parts by weight of 2,4-diamino-2,4,6,6-tetraphenoxycyclotriphosphazene, 1.5 parts by weight of polyoxyethylene (5 mol) polyoxypropylene (9 mol) octyl ether, 1.4 parts by weight of sodium salt of sulfosuccinic ester of tristyrenated phenol ethylene oxide 15 mol adduct and 0.05 part by weight of silicone defoaming agent were mixed with 35 parts by weight of water. The resulting mixture was placed in a mill containing glass beads having a diameter of 0.8 mm and pulverized for 3 hours to disperse the phosphazene compound in water as fine particles having an average particle size of 0.526 μm to obtain a dispersion. The amount of water of the thus obtained dispersion was adjusted so that the dispersion had a concentration of nonvolatile component of 30.0% by weight when the dispersion was dried at a temperature of 105° C. for 40 minutes, thereby to obtain a flame retardant treatment agent H of a comparative example.

### Comparative Example 8

### (Production of Flame Retardant Treatment Agent 1)

27 parts by weight of 2,4,6-triamino-2,4,6-triphenoxycyclotriphosphazene, 1.5 parts by weight of polyoxyethylene (5 mol) polyoxypropylene (9 mol) octyl ether, 1.4 parts by weight of sodium salt of sulfosuccinic ester of tristyrenated phenol ethylene oxide 15 mol adduct and 0.05 parts by weight of silicone defoaming agent were mixed with 35 parts by weight of water. The resulting mixture was placed in a mill containing glass beads having a diameter of 0.8 mm and pulverized for 3 hours to disperse the phosphazene compound in water as fine particles having an average particle diameter of 0.455 μm to obtain a dispersion. The amount of water of the thus obtained dispersion was adjusted so that the dispersion had a concentration of nonvolatile component of 30.0% by weight when the dispersion was dried at a temperature of 105° C. for 40 minutes, thereby to obtain a flame retardant treatment agent I of a comparative example.

### Comparative Example 9

### (Production of Flame Retardant Treatment Agent J)

27 parts by weight of hexaphenoxycyclotriphosphazene, 0.5 parts by weight of polyoxyethylene (5 mol) polyoxypropylene (9 mol) octyl ether, 1.0 part by weight of ammonium salt of sulfuric ester of tristyrenated phenol ethylene oxide 10 mol adduct and 0.05 parts by weight of silicone defoaming agent were mixed with 35 parts by weight of water. The resulting mixture was placed in a mill containing glass beads having a diameter of 0.8 mm and pulverized for 3 hours to disperse the phosphazene compound as fine particles having an average particle size of 0.478 μm to obtain a dispersion. The amount of water of the thus obtained dispersion was adjusted so that the dispersion had a concentration of nonvolatile component of 28.5% by weight when the dispersion was dried at a temperature of 105° C. for 10 minutes, thereby to obtain a flame retardant treatment agent J of a comparative example.

### C. Flame Retardant Treatment of Polyester Based Synthetic Fiber Structure

### (1) Simultaneous Dyeing and Flame Retardant Treatment in Bath

### Example 2 and Comparative Example 10

A fabric of double-sided satin weave prepared by using a regular polyester fiber made of full dull polyester fiber (containing 3.5% by weight of titanium oxide) as a warp yarn and a polyester fiber made of black spun-dyed polyester fiber as a weft yarn was scoured and preset according to a conventional method, thereby to obtain a polyester fiber fabric to be flame retarded.

Using the flame retardant treatment agent A of the invention in Example 2, while the flame retardant treatment agents H, I and J of Comparative Examples 7, 8 and 9 in Comparative Example 10, each in an amount of 6% owf (1.62% owf as a flame retardant), the polyester fiber fabric to be flame retarded was subjected to simultaneous dyeing and flame retardant treatment with a disperse dye, SUMIKARON BLUE E-RPD, in an amount of 0.2% owf at 130° C. for 40 minutes, and then dried to obtain a flame retarded polyester fabric. The results of the performance tests of the flame retarded polyester fabrics obtained are shown in Table 1.

### (1-1) Amount of Flame Retardant Adhesion

The amount of the flame retardant adhesion in the simultaneous dyeing and flame retardant treatment in a bath mentioned above was determined by subtracting the rate of weight change before and after dyeing of the polyester fabric in the absence of the flame retardant from the rate of weight change before and after the simultaneous dyeing and flame retardant treatment of the polyester fabric.

### (1-2) Exhaustion Efficiency of Flame Retardant

The exhaustion efficiency of flame retardant was calculated by dividing the amount of flame retardant adhesion as described above by the amount of flame retardant (1.62% owf) used in the simultaneous dyeing and flame retardant treatment. That is, the amount of flame retardant adhesion/amount of flame retardant used (1.62% owf)×100=the exhaustion efficiency.

### (1-3) Flame Retardant Performance Test

The flame retardant performance of the flame-retarded polyester fabric was evaluated at four points by the D method (coil method) of JIS L 1091. When the number of times of flame contact exceeded four times, the flame retardance was evaluated as good.

The test results of the performance evaluation are shown in Table 1.

TABLE 1

| | Example 2 | Comparative Example 10 | | |
|---|---|---|---|---|
| | A | H | I | J |
| Flame retardant treatment agent | | | | |
| Nonvolatile component (wt %) | 28.6 | 30.0 | 30.0 | 28.6 |
| Content of flame retardant (wt %) | 27.0 | 27.0 | 27.0 | 27.0 |
| Average particle diameter of | 0.592 | 0.526 | 0.455 | 0.478 |
| flame retardant (μm) | | | | |
| Flame retardant treatment | | | | |
| Amount of flame retardant treatment | 6 | 6 | 6 | 6 |
| agent used (% owf) | | | | |
| Amount of flame retardant used (% owf) | 1.62 | 1.62 | 1.62 | 1.62 |
| Flame retarded fabric | | | | |
| Amount of flame retardant adhesion | 1.45 | 0.95 | 0.03 | 0.25 |
| (% owf) | | | | |
| Exhasution efficiency of flame | 89.5 | 58.6 | 1.9 | 15.4 |
| retardant (%) | | | | |
| Flame retardant performance (number | 4, 5, 5, 4 | 3, 4, 3, 4 | 2, 3, 3, 3 | 3, 3, 3, 3 |
| of times of flame contact in coil method) | | | | |

### (2) Flame Retardant Treatment by Padding Method

### (2-1) Preparation of Fabric to be Flame Retarded

A polyester knit (having a basis weight of 200 g/m²) was dyed with a disperse dye, Dianix Black AM-SLR (manufactured by DyStar), at 4% owf at a temperature of 130° C. for 30 minutes in a bath, followed by reduction cleaning and drying in a conventional manner to obtain a polyester knit dyed black.

In Example 3 and the subsequent Examples and Comparative Examples, the polyester knit dyed in black as above mentioned was used as a fabric to be flame retarded.

### Example 3 and Comparative Example 11

In Example 3, the fabric to be flame retarded was subjected to flame retardant treatment with a treatment liquid obtained by diluting the flame retardant treatment agent A of the invention thereby to obtain a flame retarded polyester fabric according to the invention. In Comparative Example 11, the fabric to be flame retarded was subjected to flame retardant treatment using the flame retardant A of the invention, the flame retardant B, C, D, E, F, H, I or J of the Comparative Examples, or using a treatment liquid obtained by diluting some of the flame retardants mentioned above, thereby to obtain a flame retarded polyester fabric of comparative examples, respectively. The flame retardant performance of the fabric to be flame retarded itself is shown as “blank”. The results of flame retardant performance tests on these flame-retarded polyester fabrics are shown in Tables 2 and 3.

In Comparative Example 11, the polyester fabric which was flame retarded using the flame retardant treatment agent A of the invention provided a polyester fabric having no satisfactory flame retardance because of an insufficient amount of flame retardant adhesion.

In the above-mentioned flame retardant treatment using the flame retardant treatment agent, the amount of flame retardant adhesion was calculated based on the weight difference of the polyester fabric before and after the flame retardant treatment, the concentration of the flame retardant treatment agent diluted with water and the content of the flame retardant in the flame retardant treatment agent.

### D. Performance Test of Flame Retardance of Flame Retarded Polyester Fabric

The performance test of the flame retarded polyester fabrics obtained in Example 3 and Comparative Example 1.1 was carried out as follows. The polyester fabric to be flame retarded was treated using a flame retardant treatment agent by a padding method, dried at 100° C. for 5 minutes and dried at 130° C. for 1 minute. The flame retarded polyester fabric thus obtained was evaluated, without washing after the flame retardant treatment, i.e., as it was, in respect of friction fastness, water marks, chalk marks, bleed out, light fastness and, moisture and heat test.

Regarding the flame retardant performance, a water repellent was applied to the flame retarded polyester fabric obtained above by a padding method in a bath containing 1.0% by weight of a cationic fluorine-based water repellent agent, and then dried at 130° C., followed by drying at 150° C. for 3 minutes, thereby obtaining a flame retarded and water repellent fabric, which was then subjected to a combustion test. The water repellent agent was used as a flame retardance inhibiting substance.

### (Friction Fastness)

The flame retarded fabric was subjected to a test of color fastness to rubbing according to JIS L 0849 using a color fastness rubbing tester II (Gakushin type) described in 8.1.2 of JIS L 0849 to judge the grade for friction fastness by using a gray scale for assessing staining (JIS L 0805). Grade 5 had the highest friction fastness and grade 3 or higher was considered as good.

### (Water Mark)

5 mL of pure water, boiling water or 3% aqueous solution of calcium chloride was dropped on the surface of the flame retarded fabric put on a sheet of urethane foam, and after 24 hours, the surface of the sample was observed, respectively.

The evaluation criteria are as follows.

◯: No water marks or ring stains were generated.

x: Water marks or ring stains were generated.

### (Chalk Mark)

The surface of the flame retarded fabric was lightly rubbed with a nail and the extent of whitening due to rubbing was evaluated.

The evaluation criteria are as follows.

◯: No whitening or powder falling was observed.

x: Whitening or powder falling was observed.

### (Bleed Out)

Polyester taffeta, filter paper and a 80) g weight were put in this order on the surface of the flame retarded fabric and left standing in an atmosphere at a load of 800 g/1.5.9 cm² at a temperature of 100° C. for 2 hours, followed by evaluation of the degree of migration of flame retardant onto the polyester taffeta by using a gray scale for assessing staining (JIS L 0805). Grade 5 had the least stain and class 3 or higher was taken as good.

### (Light Fastness)

The test was conducted according to the color fastness test to UV carbon are lamp light of JIS L 0842. Using a fade meter (manufactured by Suga Test Instruments Co., Ltd.), a flame retarded fabric was irradiated with carbon are lamp light at 83° C. for 144 hours, followed by evaluation of grade of light fastness by a grey scale for assessing change in color (JIS L 0804). Grade 5 had the best fastness and grade 3 or higher was taken as good.

### (Moisture and Heat Test)

After the flame retarded fabric was left standing at a temperature of 40° C. under a relative humidity of 95% for 500 hours, it was observed if discoloration or precipitation of crystals occurred on the surface of the fabric.

The evaluation criteria are as follows.

◯: Discoloration or precipitation of crystals was not observed.

x: Discoloration or precipitation of crystals was observed.

### (Flame Retardant Performance Test)

The horizontal burning rate of the flame retarded fabric was determined based on burning test standard of automobile interior material of FMVSS (Federal Motor Vehicle Safety Standards) No. 302, and a burning rate of less than 101 mm/min was evaluated as good.

The evaluation criteria are as follows.

⊚: Flame retardant, self extinguishing;

◯: 1 mm/min to less than 61 mm/min;

Δ: 61 mm/min to less than 101 mm/min;

x: 101 mm/min or more.

The results of the test of performance evaluation are shown in Tables 2 to 3.

TABLE 2

| | Example 3 | Comparative Example 11 | | | | | | | |
|---|---|---|---|---|---|---|---|---|---|
| Flame retardant treatment agent | A | blank | A | B | C | D | E | F | G |
| Nonvolatile component (wt %) | 28.6 | — | 28.6 | 47.0 | 41.6 | 41.6 | 20.0 | 28.6 | 28.6 |
| Content of flame retardant (wt %) | 27.0 | — | 27.0 | 47.0 | 40.0 | 40.0 | 20.0 | 27.0 | 27.0 |
| Average particle diameter of | 0.592 | — | 0.592 | 0.520 | 0.547 | 1.142 | — | 0.435 | 0.444 |
| flame retardant (μm) | | | | | | | | | |
| Flame retardant treatment | | | | | | | | | |
| Amount of flame retardant | 20 | 0 | 4 | 15 | 17 | 17 | 15 | 20 | 20 |
| agent used (% ows) | | | | | | | | | |
| Flame retarded fabric | | | | | | | | | |
| Amount of flame retardant adhesion | 4.0 | 0 | 0.9 | 5.3 | 5.1 | 5.2 | 2.3 | 3.9 | 3.8 |
| (% owf) | | | | | | | | | |
| Friction fastness | | | | | | | | | |
| Dry test | 4 | 5 | 4 | 4-5 | 1-2 | 2 | 4-5 | 4 | 4 |
| Wet test | 4-5 | 5 | 4-5 | 4-5 | 1 | 1-2 | 4-5 | 4-5 | 4-5 |
| Water marks | | | | | | | | | |
| Pure water test | ◯ | ◯ | ◯ | X | X | X | X | ◯ | ◯ |
| Boiled water test | ◯ | ◯ | ◯ | X | X | X | X | ◯ | ◯ |
| Calcium chloride aqueous solution | ◯ | ◯ | ◯ | X | ◯ | ◯ | ◯ | ◯ | ◯ |
| test | | | | | | | | | |
| Chalk marks | ◯ | ◯ | ◯ | ◯ | X | ◯ | ◯ | ◯ | ◯ |
| Bleed out | 4 | 4-5 | 4 | 4 | 2 | 1-2 | 4 | 4 | 4 |
| Light fastness (83° C., 144 h) | 4 | 4-5 | 4-5 | 4-5 | 2 | 2 | 4 | 4 | 4 |
| Moisture and heat test | ◯ | ◯ | ◯ | ◯ | ◯ | ◯ | X | X | X |
| Flame retardant performance | ⊚ | X | X | ◯ | Δ | Δ | ◯ | ⊚ | ⊚ |

TABLE 3

| | Comparative Example 11 | | |
|---|---|---|---|
| | H | I | J |
| Flame retardant treatment agent | | | |
| Nonvolatile component (wt %) | 30.0 | 30.0 | 28.6 |
| Content of flame retardant (wt %) | 27.0 | 27.0 | 27.0 |
| Average particle diameter of | 0.526 | 0.455 | 0.478 |
| flame retardant (μm) | | | |
| Flame retardant treatment | | | |
| Amount of flame retardant teatment | 20 | 20 | 20 |
| agent used (% ows) | | | |
| Flame retarded fabric | | | |
| Amount of flame retardant adhesion | 3.9 | 3.9 | 3.8 |
| (% owf) | | | |
| Friction fastness | | | |
| Dry test | 4 | 4 | 4 |
| Wet test | 4-5 | 2 | 2-3 |
| Water marks | | | |
| Pure water test | ◯ | X | X |
| Boiled water test | ◯ | X | X |
| Calcium chloride aqueous solution | ◯ | ◯ | ◯ |
| test | | | |
| Chalk marks | ◯ | X | ◯ |
| Bleed out | 3-4 | 3-4 | 4 |
| Light fastness (83° C., 144 h) | 4 | 4 | 4 |
| Moisture and heat test | X | ◯ | ◯ |
| Flame retardant performance | ⊚ | ⊚ | ⊚ |

As shown in Example 3 in Table 2, the polyester fabric flame retarded using the flame retardant treatment agent A of the invention was found to be superior in flame retardance, friction fastness and light fastness. No water mark or chalk mark was generated even if it was not washed after the flame retardant treatment, and additionally discoloration or precipitation of the flame retardant under the moisture and heat test were also found to be suppressed.

However, as shown in Comparative Example 11 in Table 2, in the flame retardant treatment using the flame retardant treatment agent A, although as the amount of flame retardant adhesion to the polyester fabric was too small, the flame retardant performance of the obtained flame retarded polyester fabric was found to be unsatisfactory, it was found to stand comparison with the results of the blank in respect of any of generation of water marks, chalk marks, bleed out, frictional fastness, and the results of the moisture and heat test.

In Comparative Examples 1 to 3, the flame retardant treatment agents B, C and D were obtained by using guanidine phosphate, anilinodiphenyl phosphate and crystalline powder of tetra-(2,6-dimethylphenyl)-m-phenylene phosphate as a flame retardant, respectively. As shown in Comparative Example 11 in Table 1, when any of the flame retardant treatment agent was used, there were observed water marks on the obtained polyester fabric. In addition, as shown in Comparative Example 11 in Table 2, when either of the flame retardant treatment agents C and 1) was used, the obtained polyester fabric was found to be inferior in friction fastness and light fastness. Bleed out was also remarkable.

In Comparative Example 4, a water-soluble hexaaminocyclotriphosphazene was dissolved in water to obtain a flame retardant treatment agent E. As shown in Comparative Example 11 in Table 2, water marks was generated on the polyester fabric flame retarded with the agent E.

In Comparative Examples 5 and 6, the flame retardant treatment agents F and G were obtained by using 2,2-diamino-4,4,6,6-tetraphenoxycyclotriphosphazene and 2,2,4-triamino-4,6,6-triphenoxycyclotriphosphazene, respectively, either of which has a geminal-diamino groups in which two amino groups are bonded to the same phosphorus atom. Since these flame retardant treatment agents easily hydrolyze at the above-mentioned geminal-diamino groups of the flame retardant under the moisture and heat environments, significant discoloration was found to occur on the polyester fabric in the moisture and heat test, as shown in Comparative Example 11 in Table 2.

In Comparative Examples 7 to 9, the flame retardant treatment agent H, I and J were obtained by dissolving 2,4-diamino-2,4,6,6-tetraphenoxycyclotriphosposphazene, 2,4,6-triamino-2,4,6-triphenoxycyclotriphosphazene and hexaphenoxycyclotriphosphazene in water, respectively, as a flame retardant.

As shown in Comparative Example 11 in Table 3, as the flame retardant treatment agent H had a poor affinity with the polyester, it was found that crystalline material was precipitated over time on the surface of the flame retarded polyester fabric in the moisture and heat test.

As the flame retardant treatment agent I had also a poor affinity with the polyester, there were generated water marks or chalk marks on the flame retarded fabric. As the flame retardant treatment agent J had also a poor affinity with the polyester, there were generated water marks on the flame retarded fabric.

In Example 2 and Comparative Example 10, the polyester fabric to be flame retarded was subjected to flame retardant treatment in a bath using the flame retardant treatment agent A obtained by dispersing aminopentaphenoxycyclotriphosphazene in water, which hardly hydrolyzes, according to the invention, the flame retardant treatment agent H obtained by dispersing 2,4-diamino-2,4,6,6-tetraphenoxycyclotriphosphazene in water, which hardly hydrolyzes, as a comparative example, the flame retardant treatment agent I obtained by dispersing 2,4,6-triamino-2,4,6-triphenoxycyclotriphosphazene in water, and the flame retardant treatment agent J obtained by dispersing hexaphenoxytriphosphazene in water, respectively, at a flame retardant concentration of 1.62% owf in relation to the polyester fabric.

It was found that the flame retardant treatment agent A had an adhesion amount of 1.45% owf and an exhaustion efficiency of 89.5% as shown in Example 2, whereas the flame retardant treatment agent H had an adhesion amount of 0.95% owf, and an exhaustion efficiency of 58.6%, the flame retardant treatment agent I had an adhering amount of 0.03% owf, and an exhaustion efficiency of 1.9%, the flame retardant treatment agent J had an adhesion amount of 0.25% owf and an exhaustion efficiency of 15.4% as shown in Comparative Example 10. In view of the above results, the aminopentaphenoxycyclotriphosphazene was found to have a particularly high affinity with the polyester fabric among the aminophenoxyphosphazenes which hardly hydrolyze.

### Example 4

### (Production of Flame Retardant Agent K)

27 parts by weight of aminopentaphenoxycyclotriphosphazene, 0.1.0 part by weight of sorbitan monooleate ethylene oxide 6 mol adduct, 1.5 parts by weight of sodium salt of sulfuric ester of cumylphenol ethylene oxide 11 mol adduct and 0.05 parts by weight of silicone defoaming agent were mixed with 35 parts by weight of water. The mixture was placed in a mill containing glass beads having a diameter of 0.8 mm and pulverized for 3 hours to disperse the flame retardant in water as fine particles having an average particle diameter of 0.674 μm to prepare a dispersion. The amount of water of the thus obtained dispersion was adjusted so that the dispersion had a concentration of nonvolatile component of 29.6% by weight when the dispersion was dried at a temperature of 105° C. for 40 minutes, thereby to obtain a flame retardant treatment agent K of the invention.

### Example 5

### (Production of Flame Retardant Agent L)

27 parts by weight of aminopentaphenoxycyclotriphophosphazene, 0.5 parts by weight of polyoxyethylene (18 mol) polyoxypropylene (12 mol) octyl ether, 1.5 parts by weight of sodium salt of sulfuric ester of distyrenated phenol ethylene oxide 14 mol adduct and 0.05 parts by weight of silicone defoaming agent were mixed with 35 parts by weight of water. The mixture was put in a mill containing glass beads having a diameter of 0.8 mm and pulverized for 3 hours to disperse the flame retardant in water as fine particles having an average particle size of 0.520 μm to obtain a dispersion. The amount of water of the thus obtained dispersion was adjusted so that the dispersion had a concentration of nonvolatile component of 29.1% by weight when the dispersion was dried at a temperature of 1.05° C. for 40 minutes, thereby to obtain a flame retardant treatment agent L of the invention.

### Example 6

### (Production of Flame Retardant Agent M)

27 parts by weight of aminopentaphenoxycyclotriphosphazene, 1.0 part by weight of polyoxyethylene (18 mol) polyoxypropylene (12 mol) octyl ether, 1.0 part by weight of butylnaphthalene sulfonic acid sodium salt, and 0.05 parts by weight of silicone defoaming agent were mixed with 35 parts by weight of water. The mixture was put in a mill containing glass beads having a diameter of 0.8 mm and pulverized for 3 hours to disperse the flame retardant as fine particles having an average particle size of 0.536 μm to obtain a dispersion. The amount of water of the thus obtained dispersion was adjusted so that the dispersion had a concentration of nonvolatile component of 29.1% by weight when the dispersion was dried at a temperature of 105° C. for 40 minutes, thereby to obtain a flame retardant treatment agent M of the invention.

### Example 7

### (Production of Flame Retardant Agent N)

27 parts by weight of aminopentaphenoxycyclotriphosphazene, 0.5 parts by weight of distyrenated phenol ethylene oxide 13 mol adduct, 1.5 parts by weight of ammonium salt of sulfuric ester of tristyrenated phenol ethylene oxide 7 mol adduct and 0.05 parts by weight of silicone defoaming agent were mixed with 35 parts by weight of water. The mixture was put in a mill containing glass beads having a diameter of 0.8 mm and pulverized for 3 hours to disperse the flame retardant in water as fine particles having an average particle size of 0.454 μm to obtain a dispersion. The amount of water of the thus obtained dispersion was adjusted so that the dispersion had a concentration of nonvolatile component of 29.1% by weight when the dispersion was dried at a temperature of 105° C. for 40 minutes, thereby to obtain a flame retardant treatment agent N of the invention.

### (3) Flame Retardant Treatment by Padding Method

### (3-1) Preparation of Polyester Fabric to be Flame Retarded

A polyester knit (basis weight of 200 g/m²) was dyed with a disperse dye, Dianix Black AM-SLR (manufactured by DyStar), at 4% owf in a bath at a temperature of 130° C. for 30 minutes, followed by reduction cleaning and drying in a conventional manner to obtain a polyester knit dyed black.

In Example 8, the above-mentioned polyester fabric to be flame retarded was subjected to flame retardant treatment by using the treatment liquids obtained by diluting the flame retardant treatment agents K, L, M, and N of the invention with water, respectively, to obtain a flame retarded polyester fabric of the invention. The results of performance tests for the flame retarded polyester fabrics thus obtained are shown in Table 4.

As shown in Example 8 of Table 4, any of the polyester fabric subjected to flame retardant treatment by using the flame retardant treatment agents K, L, M, and N, respectively, each comprising aminopentaphenoxycyclotriphosphazene as a flame retardant, was found to be superior in flame retardance, friction fastness and light fastness, and had no water marks or chalk marks thereon even if it was not washed after the flame retardant treatment. Further, discoloration and precipitation of the flame retardant used were also found to be suppressed in the moisture and heat test.

In the flame retardant treatment using the flame retardant treatment agent mentioned above, the amount of flame retardant adhesion was calculated based on the weight difference of the polyester fabric before and after the flame retardant treatment, the concentration of the flame retardant treatment agent diluted with water, and the content of the flame retardant in the flame retardant treatment agent.

### E. Performance Test

Performance test of flame retardance of polyester fabric flame retarded in Example 8 was carried out as follows. That is, the fabric to be treated was flame retarded using the flame retardant treatment agent of the invention by a padding method, dried at 100° C. for 5 minutes and then dried at 130° C. for 1 minute. The flame retarded polyester fabric thus obtained was evaluated with respect to friction fastness, water marks, chalk marks, bleed out, light fastness, and moisture and heat test as it was without washing after the flame retardant treatment.

Regarding the flame retardant performance, a water repellent was applied to the flame retarded polyester fabric obtained above by a padding method in a bath containing 1.0% by weight of a cationic fluorine-based water repellent agent, and then dried at 1.30° C. followed by heat treating at 150° C. for 3 minutes thereby obtaining a flame retarded and water repellent fabric, which was subjected to a combustion test. The water repellent agent was used as a flame retardance inhibiting substance.

### (Friction Fastness)

The flame retarded fabric was subjected to a test of color fastness to rubbing according to JIS L 0849 using a color fastness rubbing tester II (Gakushin type) described in 8.1.2 of JIS L 0849 to evaluate the grade for friction fastness by using a gray scale for assessing staining (JIS L 0805). Grade 5 had the highest friction fastness and grade 3 or higher was taken as good.

### (Water Mark)

5 mL of pure water, boiling water or 3% aqueous solution of calcium chloride was dropped on the surface of the flame retarded fabric put on a sheet of urethane foam, and after 24 hours, the surface of the sample was observed, respectively.

The evaluation criteria are as follows.

◯: No water marks or ring stains were generated.

x: Water marks or ring stains were generated.

### (Chalk Marks)

The surface of flame retarded fabric was lightly rubbed with a nail and the extent of whitening was evaluated.

The evaluation criteria are as follows.

◯: No whitening or powder falling was observed.

x: Whitening or powder falling was observed.

### (Bleed Out)

Polyester taffeta, filter paper and a 800 g weight were put in this order on the surface of the flame retarded fabric and left standing in an atmosphere at a load of 800 g/15.9 cm⁹ at a temperature of 100° C. for 2 hours, followed by evaluation of the degree of migration of flame retardant onto the polyester taffeta by using a gray scale for assessing staining (JIS L 0805). Grade 5 had the least stain and class 3 or higher was taken as good.

### (Light Fastness)

The test was conducted according to the color fastness test to UV light carbon arc lamp light of JIS L 0842. Using a fade meter (manufactured by Suga Test Instruments Co., Ltd.), a flame retarded fabric was irradiated with a UV carbon are lamp light at 83° C. for 144 hours, followed by evaluation of grade of light fastness by a grey scale for assessing change in color (JIS L 0804). Grade 5 had the best fastness and grade 3 or higher was taken as good.

### (Moisture and Heat Test)

After the flame retarded fabric was left standing at a temperature of 40° C. under a relative humidity of 95% for 500 hours, it was observed if discoloration or precipitation of crystals occurred on the surface of the fabric.

The evaluation criteria are as follows.

◯: Discoloration or precipitation of crystals was not observed.

x: Discoloration or precipitation of crystals was observed.

### (Flame Retardant Performance Test)

The horizontal burning rate of the flame retarded fabric was determined based on burning test standard of automobile interior material of FMVSS (Federal Motor Vehicle Safety Standards) No. 302, and a burning rate of less than 101 mm/min was evaluated as good.

The evaluation criteria are as follows.

⊚: Flame retardant, self extinguishing;

◯: 1 mm/min to less than 61 mm/min;

Δ: 61 mm/min to less than 101 mm/min;

x: 101 mm/min or more.

The results of the test of performance evaluation are shown in Tables 4.

TABLE 4

| | Example 8 | | | |
|---|---|---|---|---|
| | K | L | M | N |
| Flame retardant treatment agent | | | | |
| Nonvolatile component (wt %) | 29.8 | 29.1 | 29.1 | 29.1 |
| Content of flame retardant (wt %) | 27.0 | 27.0 | 27.0 | 27.0 |
| Average particle diameter of | 0.674 | 0.520 | 0.536 | 0.454 |
| flame retardant (μm) | | | | |
| Flame retardant treatment | | | | |
| Amount of flame retardant | 20 | 20 | 20 | 20 |
| treatment agent used (% ows) | | | | |
| Flame retarded fabric | | | | |
| Amount of flame retardant | 4.0 | 3.9 | 3.8 | 3.9 |
| adhesion (% owf) | | | | |
| Friction fastness | | | | |
| Dry test | 4 | 4 | 4 | 4-5 |
| Wet test | 4-5 | 4-5 | 4-5 | 4-5 |
| Water marks | | | | |
| Pure water test | ◯ | ◯ | ◯ | ◯ |
| Boiled water test | ◯ | ◯ | ◯ | ◯ |
| Calcium chloride aqueous solution | ◯ | ◯ | ◯ | ◯ |
| test | | | | |
| Chalk marks | ◯ | ◯ | ◯ | ◯ |
| Bleed out | 3-4 | 4 | 4 | 4 |
| Light fastness (83° C., 144 h) | 4 | 4 | 4 | 4 |
| Moisture and heat test | ◯ | ◯ | ◯ | ◯ |
| Flame retardant performance | ⊚ | ⊚ | ⊚ | ⊚ |

1. A flame retardant for a polyester based synthetic fiber structure comprising aminopentaphenoxycyclotriphosphazene represented by the structural formula (1)

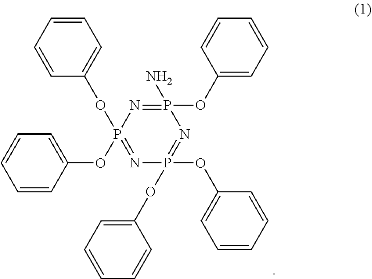 [SMILES: NP1(Oc2ccccc2)=NP(Oc2ccccc2)(Oc2ccccc2)=NP(Oc2ccccc2)(Oc2ccccc2)=N1]

2. A flame retardant treatment agent for a polyester based synthetic fiber structure comprising the flame retardant according to claim 1 dispersed in a solvent in the presence of a surfactant.

3. The flame retardant treatment agent for a polyester based synthetic fiber structure according to claim 2, wherein the solvent is water.

4. A polyester based synthetic fiber structure flame retarded with the flame retardant according to claim 1.

5. A method for flame retardant treatment of a polyester based synthetic fiber structure comprising subjecting a polyester based synthetic fiber structure to flame retarding treatment with the flame retardant treatment agent according to claim 2.

6. A method for flame retardant treatment of a polyester based synthetic fiber structure comprising providing a polyester based synthetic fiber structure with the flame retardant treatment agent according to claim 2, drying, and then heat treating at a temperature of 80 to 200° C.

7. A polyester based synthetic fiber structure flame retarded by the method according to claim 5.

8. A method for flame retardant treatment of a polyester based synthetic fiber structure comprising subjecting a polyester based synthetic fiber structure to flame retarding treatment with the flame retardant treatment agent according to claim 3.

9. A method for flame retardant treatment of a polyester based synthetic fiber structure comprising providing a polyester based synthetic fiber structure with the flame retardant treatment agent according to claim 3, drying, and then heat treating at a temperature of 80 to 200° C.

10. A polyester based synthetic fiber structure flame retarded by the method according to claim 6.
